(19) United States
(12) Patent Application Publication
(10) Pub. No.: US 2006/0290023 A1
(43) Pub. Date: Dec. 28, 2006

(54) METHOD OF MANUFACTURING A RUBBER WOVEN RUG

(76) Inventor: Sanjeev Koncherry Suseelan, Mayithara (IN)

Correspondence Address: MEREDITH & KEYHANI, PLLC, 330 MADISON AVE., 6TH FLOOR, NEW YORK, NY, 10017, US

(21) Appl. No.: 11/464,311

(22) Filed: Aug. 14, 2006

Related U.S. Application Data
(63) Continuation-in-part of application No. PCT/IN04/00350, filed on Nov. 10, 2004.

(51) Int. Cl. D03D 49/50; B29C 41/24

(52) U.S. Cl. 264/165; 139/116.1

(57) ABSTRACT

A method of manufacturing a rubber woven rug, the method comprising the steps of: mixing raw materials; extruding the raw materials through at least one mould to produce a rubber yarn; vulcanizing the rubber yarn in a steam chamber to provide vulcanized yarn; loading vulcanized yarn on a loom; and weaving said vulcanized yarn to provide a rubber woven rug.

This is a continuation in part and claims priority to international application number PCT/IN2004/000350 filed Nov. 10, 2004 which is currently pending.

This invention in general relates to textile technology. More particularly this invention relates to manufacturing of doormats and rugs made of rubber yarn. This invention relates to a manufacturing process of doormats and rugs having rubber yarn either in solid threads or as rubber tubes.

Rubber mats are very durable and versatile. Typically, rubber mats are made from molds and poured. However, such a process of manufacturing makes it very difficult to achieve certain designs and sizes. Accordingly, the present invention provides for the first time a rug manufactured of rubber yarns or tapes of solid as well as hollow tubes. Because the rug is made using rubber yarns and weaving techniques, the product becomes a versatile, affordable and softer than rugs made from molded plastic. It also offers high utility and convenience of usage. The product is washable and may be made is vibrant colors. The product is also unique, rugged and economical.

Another advantage of the present invention is that because the product is made of natural rubber and with all natural products, it is biodegradable and hence environmentally friendly. The product does not cause the production of fungus and different conditions do not alter the product's nature and can be used indoor or outdoor. Prior art woven rugs would mold and alter if used outside. Further, the woven texture provides dirt and debris removing qualities.

Accordingly, the present invention provides a woven rubber rug

### SUMMARY OF THE INVENTION

The present invention relates generally to methods of manufacturing doormats and rugs made of rubber yarn.

A method of manufacturing a rubber woven rug, the method comprising the steps of: mixing raw materials; extruding the raw materials through at least one mould to produce a rubber yarn; vulcanizing the rubber yarn in a steam chamber to provide vulcanized yarn; loading the vulcanized yarn on a loom; and weaving the vulcanized yarn to provide a rubber woven rug.

A method of manufacturing a rubber woven rug, the method comprising the steps of: mixing raw materials, wherein the raw materials are between 15 and 20 percent natural rubber, between 15 and 20 percent reclaimed rubber, between 0.1 and 1.0 percent stearic acid, between 0.1 and 1 percent zinc oxide, between 0.1 and 1.0 percent sulphur, between 20 and 40 percent barites, between 0.1 and 1.0 percent mer cure, between 5 and 15 percent rubber process oil and between 10 and 20 percent tyre powder; extruding the raw materials through at least one mould to produce a rubber yarn; vulcanizing the rubber yarn in a steam chamber to provide vulcanized yarn; loading the vulcanized yarn on a loom; and weaving the vulcanized yarn to provide a rubber woven rug.

A method of manufacturing a rubber woven rug, the method comprising the steps of: mixing raw materials wherein the raw materials are about 17.5 percent natural rubber, 17.5 percent reclaimed rubber, 0.65 percent stearic acid, 0.60 percent zinc oxide, 0.45 percent sulphur, 35 percent barites, 0.3 percent mer cure, 10.5 percent rubber process oil and 17.5 percent tyre powder; extruding the raw materials through at least one mould to produce a rubber yarn; vulcanizing the rubber yarn in a steam chamber to provide vulcanized yarn; loading the vulcanized yarn on a loom; and weaving the vulcanized yarn to provide a rubber woven rug.

These and other features, aspects and advantages of the present invention will become better understood with reference to the following description and claims.

### BRIEF DESCRIPTION OF THE DRAWINGS

FIG. 1 depicts a rug manufactured according to the present invention.

### DETAILED DESRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

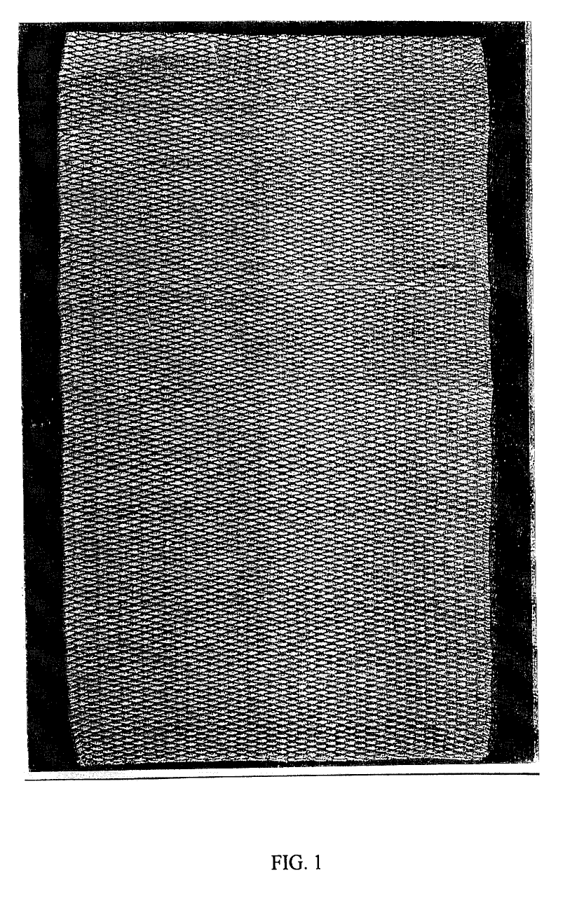

As shown in FIG. 1, the present invention provides a method of manufacturing a rubber woven rug, the method comprising the steps of: mixing raw materials; extruding the raw materials through at least one mould to produce a rubber yarn; vulcanizing said rubber yarn in a steam chamber to provide vulcanized yarn; loading said vulcanized yarn on a loom; and weaving said vulcanized yarn to provide a rubber woven rug.

The raw materials may be selected from the group consisting of Natural Rubber, Synthetic Rubber, Reclaimed Rubber, Stearic Acid, Zinc Oxide, Sulpher, Barites, Clay, Silica, Carbon Black, Calcium Carbonate, Aluminium Silicate, Accelerator (MBTS (2,2-Dibenzothiazole disulfide), MBT (2-Mercaptobenzothiazole), DPG (Diphenyl guanidine), CBS (N-Cyclohexyl-2-), TMTD (Tetramethyl thiuram disulfide)), Naphthenic oil, Aromatic oil, Crumb Rubber powder, antioxidants, Colouring agents and Titanium Dioxide. The term antioxidants is intended to all antioxidants known within the art. By way of example, but without limitation this may include various combinations of hs, bl and/or sp (styrenated phenol). For example, HS/TQ may be Polymerised 1,2 dihydro-2,4 trimethyl quinoline, a quinoline type antioxidant. B/BL/BLN are Contensation product s of acetone and Diphenyl amine

It is envisioned that different combinations of natural rubber, reclaimed rubber and synthetic rubber may be used. According to one embodiment, the raw materials may be between 10 and 80 percent natural rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

According to another embodiment, the raw materials may be between 5 and 75 percent natural rubber, between 5 and 60 percent reclaimed rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

According to yet another embodiment, raw materials may be between 10 and 80 percent synthetic rubber (SBR), between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

According to still yet another embodiment, the raw materials nay be between 5 and 75 percent synthetic rubber (SBR), between 5 and 50 percent reclaimed rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

According to a preferred embodiment, the raw materials may be between 15 and 20 percent natural rubber, between 15 and 20 percent reclaimed rubber, between 0.1 and 1.0 percent stearic acid, between 0.1 and 1 percent zinc oxide, between 0.1 and 1.0 percent sulphur, between 20 and 40 percent barites, between 0.1 and 1.0 percent mer cure, between 5 and 15 percent rubber process oil and between 10 and 20 percent tyre powder. There may also be a coloring agent added according to the desired color.

The vulcanized yarn according to a preferred embodiment may be loaded on weft. As would be known by those of ordinary skill in the art, the warp would be the threads, yarns, etc. that run lengthwise in a woven fabric and the weft refers to the thread, yarns, etc. are the cross-wise yarns. According to the present invention, there may be a second thread or yarn for warp material. The warp material may be selected from the group consisting of coir, jute, sisal, grass, cotton, polyester, poly propylene, rubber thread, plastic, nylon, paper, BCF and wool.

Once desirable aspect of the present invention is that a woven rug may be made of any size. Prior art rubber rugs are typically injection molded and therefore are limited in terms of their size. Here, the desired diameter of the rubber material may be changed to provide different diameters by selecting different moulds to provide different diameter rubber yarn.

The present invention is intended for use on the walk way of a house or a building, can be used for the purpose of laying on the floor where people have to stand for a long time such as counters at the airport, banks, railway stations, bus stations, boat houses, immigration counters, cinema halls, super markets, behind any counter where people stand and transact and interact with people customers and in hotel or restaurant kitchens. This product can be put on the floor as well as can be fixed on the walls of children play rooms and gymnasiums as a protection against hazardous impacts. The product can be used in work places as a safety measure against electric shock, in construction sites where people stand and in bathrooms like inside the tub to avoid slipping.

It should be understood that the foregoing relates to preferred embodiments of the invention and that modifications may be made without departing from the spirit and scope of the invention as set forth in the following claims.

I claim:

1. A method of manufacturing a rubber woven rug, said method comprising the steps of:
mixing raw materials;
extruding said raw materials through at least one mould to produce a rubber yarn;
vulcanizing said rubber yarn in a steam chamber to provide vulcanized yarn;
loading said vulcanized yarn on a loom; and
weaving said vulcanized yarn to provide a rubber woven rug.

2. A method as in claim 1, wherein said step of loading said vulcanized yarn on said loom is loaded on weft.

3. A method as in claim 1, further comprising the step of:
providing a second thread or yarn for warp material.

4. A method as in claim 3, wherein said warp material is selected from the group consisting of coir, jute, sisal, grass, cotton, polyester, poly propylene, rubber thread, plastic, nylon, paper, BCF and wool.

5. A method as in claim 1, wherein said raw materials are selected from the group consisting of Natural Rubber, Synthetic Rubber, Reclaimed Rubber, Stearic Acid, Zinc Oxide, Sulpher, Barites, Clay, Silica, Carbon Black, Calcium Carbonate, Aluminium Silicate, Accelerator (MBTS, MBT, DPG, CBS, TMTD), Naphthenic oil, Aromatic oil, Crumb Rubber powder, antioxidants, Colouring agents and Titanium Dioxide.

6. A method as in claim 1, wherein said raw materials are about 17.5 percent natural rubber, 17.5 percent reclaimed rubber, 0.65 percent stearic acid, 0.60 percent zinc oxide, 0.45 percent sulphur, 35 percent barites, 0.3 percent mer cure, 10.5 percent rubber process oil and 17.5 percent tyre powder.

7. A method as in claim 1, wherein said raw materials are between 15 and 20 percent natural rubber, between 15 and 20 percent reclaimed rubber, between 0.1 and 1.0 percent stearic acid, between 0.1 and 1 percent zinc oxide, between 0.1 and 1.0 percent sulphur, between 20 and 40 percent barites, between 0.1 and 1.0 percent mer cure, between 5 and 15 percent rubber process oil and between 10 and 20 percent tyre powder.

8. A method as in claim 1, wherein said raw materials are between 10 and 80 percent natural rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

9. A method as in claim 1, wherein said raw materials are between 5 and 75 percent natural rubber, between 5 and 60 percent reclaimed rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

10. A method as in claim 1, wherein said raw materials are between 10 and 80 percent synthetic rubber (SBR), between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

11. A method as in claim 1, wherein said raw materials are between 5 and 75 percent synthetic rubber (SBR), between 5 and 50 percent reclaimed rubber, between 0.2 and 2 percent zinc oxide, between 0.2 and 1.5 percent stearic acid, between 0.2 and 1.5 percent sulphur, between 0.1 and 1.5 percent accelerators, between 0 and 75 percent berites, between 0 and 75 percent clay, between 0 and 25 percent silica, between 0 and 25 percent carbon black, between 0 and 60 percent calcium carbonate, between 0 and 60 percent aluminum silicate, between 0 and 10 percent naphthenic oil, between 0 and 10 percent aromatic oil, between 0 and 40 percent crumb rubber powder, between 0.1 and 2 percent anti oxidants, between 0.1 and 2.5 percent coloring agents and between 0.1 and 5 percent titanium dioxide.

12. A method as in claim 1, wherein said mold is selected according to the desired diameter.

13. A method of manufacturing a rubber woven rug, said method comprising the steps of:
mixing raw materials, wherein said raw materials are between 15 and 20 percent natural rubber, between 15 and 20 percent reclaimed rubber, between 0.1 and 1.0 percent stearic acid, between 0.1 and 1 percent zinc oxide, between 0.1 and 1.0 percent sulphur, between 20 and 40 percent barites, between 0.1 and 1.0 percent mer cure, between 5 and 15 percent rubber process oil and between 10 and 20 percent tyre powder;
extruding said raw materials through at least one mould to produce a rubber yarn;
vulcanizing said rubber yarn in a steam chamber to provide vulcanized yarn;
loading said vulcanized yarn on a loom; and
weaving said vulcanized yarn to provide a rubber woven rug.

14. A method as in claim 13, wherein said step of loading said vulcanized yarn on said loom is loaded on weft.

15. A method as in claim 13, further comprising the step of:
providing a second thread or yarn for warp material.

16. A method as in claim 13, wherein said warp material is selected from the group consisting of coir, jute, sisal, grass, cotton, polyester, poly propylene, rubber thread, plastic, nylon, paper, BCF and wool.

17. A method as in claim 13, wherein said raw materials are about 17.5 percent natural rubber, 17.5 percent reclaimed rubber, 0.65 percent stearic acid, 0.60 percent zinc oxide, 0.45 percent sulphur, 35 percent barites, 0.3 percent mer cure, 10.5 percent rubber process oil and 17.5 percent tyre powder.

18. A method as in claim 13, wherein said mold is selected according to the desired diameter.

19. A method of manufacturing a rubber woven rug, said method comprising the steps of:
mixing raw materials wherein said raw materials are about 17.5 percent natural rubber, 17.5 percent reclaimed rubber, 0.65 percent stearic acid, 0.60 percent zinc oxide, 0.45 percent sulphur, 35 percent barites, 0.3 percent mer cure, 10.5 percent rubber process oil and 17.5 percent tyre powder;
extruding said raw materials through at least one mould to produce a rubber yarn;
vulcanizing said rubber yarn in a steam chamber to provide vulcanized yarn;
loading said vulcanized yarn on a loom; and
weaving said vulcanized yarn to provide a rubber woven rug.

20. A method as in claim 19, wherein said step of loading said vulcanized yarn on said loom is loaded on weft.

21. A method as in claim 19, further comprising the step of:
providing a second thread or yarn for warp material.

22. A method as in claim 19, wherein said warp material is selected from the group consisting of coir, jute, sisal, grass, cotton, polyester, poly propylene, rubber thread, plastic, nylon, paper, BCF and wool.

23. A method as in claim 19, wherein said raw materials are selected from the group consisting of Natural Rubber, Synthetic Rubber, Reclaimed Rubber, Stearic Acid, Zinc Oxide, Sulpher, Barites, Clay, Silica, Carbon Black, Calcium Carbonate, Aluminium Silicate, Accelerator (MBTS, MBT, DPG, CBS, TMTD), Naphthenic oil, Aromatic oil, Crumb Rubber powder, Antioxidants, Colouring agents and Titanium Dioxide.
